(19) United States
(12) Patent Application Publication
(10) Pub. No.: US 2013/0124684 A1
(43) Pub. Date: May 16, 2013

(54) VISUAL SEPARATOR DETECTION IN WEB PAGES USING CODE ANALYSIS

(71) Applicants: Li-Wei Zheng, Beijing (CN); Jian Fan, San Jose, CA (US); Hui-Man Hou, Beijing (CN); Jian Ming Jin, Beijing (CN); Suk Hwan Lim, Mountain View, CA (US)

(72) Inventors: Li-Wei Zheng, Beijing (CN); Jian Fan, San Jose, CA (US); Hui-Man Hou, Beijing (CN); Jian Ming Jin, Beijing (CN); Suk Hwan Lim, Mountain View, CA (US)

(21) Appl. No.: 13/812,092

(22) PCT Filed: Jul. 30, 2010
(86) PCT No.: PCT/CN2010/075580

§ 371 Date: Jan. 24, 2013

(51) Int. Cl. H04L 29/08

(52) U.S. Cl. CPC H04L 29/0809
USPC 709/217

(57) ABSTRACT

A method for detection of visual separators in web pages using code analysis includes receiving a web page and its associated web code by a web page analysis device and analyzing the web code to detect visual separators in the web page. A web page analysis device for visual separator detection in web pages is also provided.

### BACKGROUND

Web pages located on the World Wide Web and accessed via the Internet include a variety of content including text, images, and other forms of multimedia. These web pages are often divided into multiple portions or regions by horizontal lines, vertical lines, and frames. These lines are separator lines.

When viewed in terms of web page design, content located within the different regions of the web page defined by the separator lines have different semantic meanings (i.e., the relationships of characters or groups of characters to their meanings, independent of the manner of their interpretation and use) or document functions (e.g., a portion of an article or a sidebar). Being able to detect separator lines within the web pages is very useful in subsequent processing of a web page including, for example, web page printing, block level based web page searching, web page segmentation, and many other applications.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative system for detecting separator lines in a web page, according to one exemplary embodiment of principles described herein.

FIG. 2A is a flowchart depicting an illustrative visual separator detection method, according to one embodiment of principles described herein.

FIG. 2B is a Document Object Model (DOM) tree for an illustrative web page, according to one embodiment of principles described herein.

FIG. 2C is diagram of an illustrative web page showing the content of the web page, according to one embodiment of principles described herein.

FIG. 2D is a diagram of visual separators identified by the visual separator detection method, according to one embodiment of principles described herein.

Throughout the drawings, identical reference numbers designate similar, but not necessarily identical, elements.

### DETAILED DESCRIPTION

Web pages provide an inexpensive and convenient way to make information available to its consumers. However, as the inclusion of multimedia content, embedded advertising, and online services becomes increasingly more prevalent in modern web pages, the web pages themselves have become substantially more complex. For example, in addition to their main content, many web pages display auxiliary content such as background imagery, advertisements, or navigation menus, and links to additional content. Web pages are often divided into multiple parts or segments by horizontal lines, vertical lines, and frames.

The detection of these visual separators can assist in a number of web page operations. For example, owners or consumers of web pages may wish to utilize or adapt only a portion of the information presented in a web page. The visual separators may assist in automatically defining segments contained in a web page. Once the content of the web page is divided into segments, the segments which contain the desired information can be identified and the remainder of the segments discarded. For instance, a user may desire to print a physical copy of an internet article without reproducing any of the irrelevant content on the web page containing the article. Visual separators can be one indicator which allows for the print-worthy content to be segmented from other information such as advertisements, headers, footers, or other extraneous information. Visual separators could be used in a variety of other applications such as porting web pages to mobile devices with limited screen sizes, clipping web content for inclusion into a composite document, search, information retrieval, information management, archiving, and other applications.

There are a number of challenges in correctly and automatically identifying visual separators from web page code. For example, web pages vary widely by content type. Common types of web pages include: news, shopping, blog, map, and recipe web pages. The web page layouts also vary widely across the different types of web pages. The web pages also included a variety of content, including text, images, video and flash. To effectively extract visual separators from the web page code, visual separator algorithm uses a number of techniques, including: identification DOM tag names which denote visual separation, analysis of border properties, detecting color differences and identifying image repetition.

As used in the present specification and in the appended claims, the term “web page” refers to a document that can be retrieved from a server over a network connection and viewed in a web browser application. The term “visual separator” refers to an element or arrangement of elements in a web page which graphically partition a web page into coherent segments. As used in the present specification and in the appended claims, the term “coherent,” as applied to a web page segment, refers to the characteristic of having content/functionality of the same type or property.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

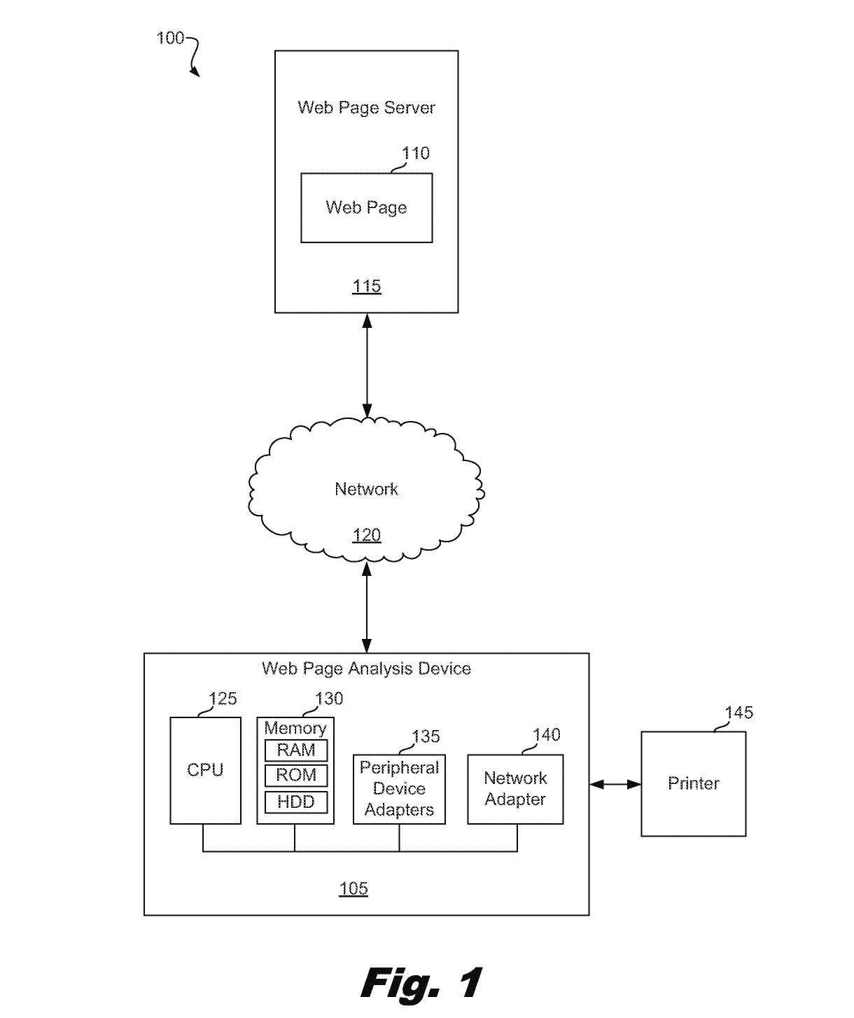

Referring now to FIG. 1, an illustrative system (100) for automatic detection of visual separators in web pages includes a web page analysis device (105) that has access to a web page (110) stored by a web page server (115). In the present example, for the purposes of simplicity in illustration, the web page analysis device (105) and the web page server (115) are separate computing devices communicatively coupled to each other through a mutual connection to a network (120). However, the principles set forth in the present specification extend equally to any alternative configuration in which a web page analysis device (105) has complete access to a web page (110). As such, alternative embodiments within the scope of the principles of the present specification include, but are not limited to, embodiments in which the web page analysis device (105) and the web page server (115) are implemented by the same computing device, embodiments in which the functionality of the web page analysis device (105) is implemented by a multiple interconnected computers (e.g., a server in a data center and a user's client machine), embodiments in which the web page segmentation device (105) and the web page server (115) communicate directly through a bus without intermediary network devices, and embodiments in which the web page analysis device (105) has a stored local copy of the web page (110) which is to be analyzed to automatically select its main content.

The web page analysis device (105) of the present example is a computing device configured to retrieve the web page (110) hosted by the web page server (115) and identify visual separators within the web page (110) using code analysis. In the present example, this is accomplished by the web page analysis device (105) requesting the web page (110) from the web page server (115) over the network (120) using the appropriate network protocol (e.g., Internet Protocol (“IP”)). Illustrative processes for automatic selection of the main content in web pages are set forth in more detail below.

To achieve its desired functionality, the web page analysis device (105) includes various hardware components. Among these hardware components may be at least one processing unit (125), at least one memory unit (130), peripheral device adapters (135), and a network adapter (140). These hardware components may be interconnected through the use of one or more busses and/or network connections.

The processing unit (125) may include the hardware architecture necessary to retrieve executable code from the memory unit (130) and execute the executable code. The executable code may, when executed by the processing unit (125), cause the processing unit (125) to implement at least the functionality of retrieving the web page (110) and analyze a web page (110) for automatic selection of its main content according to the methods of the present specification described below. In the course of executing code, the processing unit (125) may receive input from and provide output to one or more of the remaining hardware units.

The memory unit (130) may be configured to digitally store data consumed and produced by the processing unit (125). The memory unit (130) may include various types of memory modules, including volatile and nonvolatile memory. For example, the memory unit (130) of the present example includes Random Access Memory (RAM), Read Only Memory (ROM), and Hard Disk Drive (HDD) memory. Many other types of memory are available in the art, and the present specification contemplates the use of any type(s) of memory (130) in the memory unit (130) as may suit a particular application of the principles described herein. In certain examples, different types of memory in the memory unit (130) may be used for different data storage needs. For example, in certain embodiments the processing unit (125) may boot from ROM, maintain nonvolatile storage in the HDD memory, and execute program code stored in RAM.

The hardware adapters (135, 140) in the web page analysis device (105) are configured to enable the processing unit (125) to interface with various other hardware elements, external and internal to the web page analysis device (105). For example, peripheral device adapters (135) may provide an interface to input/output devices to create a user interface and/or access external sources of memory storage. Peripheral device adapters (135) may also create an interface between the processing unit (125) and a printer (145) or other media output device. For example, in embodiments where the web page analysis device (105) is configured to generate a document based on functional blocks extracted from the web page's content, the web page analysis device (105) may be further configured to instruct the printer (145) to create one or more physical copies of the document.

A network adapter (140) may provide an interface to the network (120), thereby enabling the transmission of data to and receipt of data from other devices on the network (120), including the web page server (115).

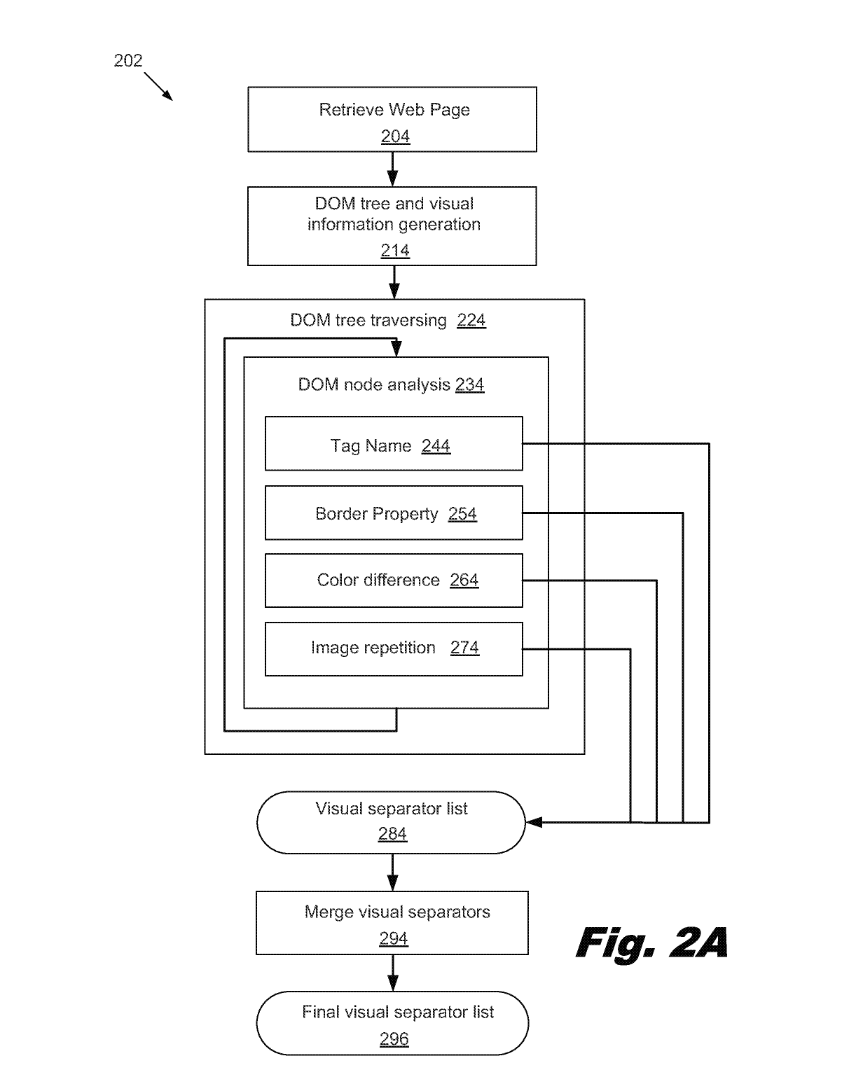

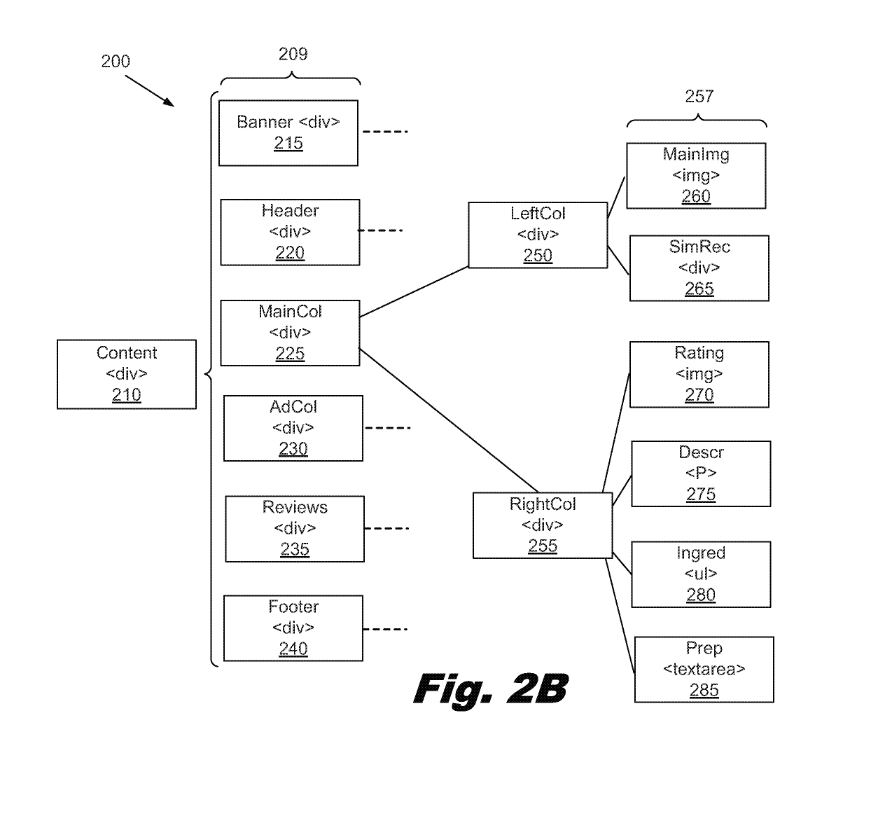

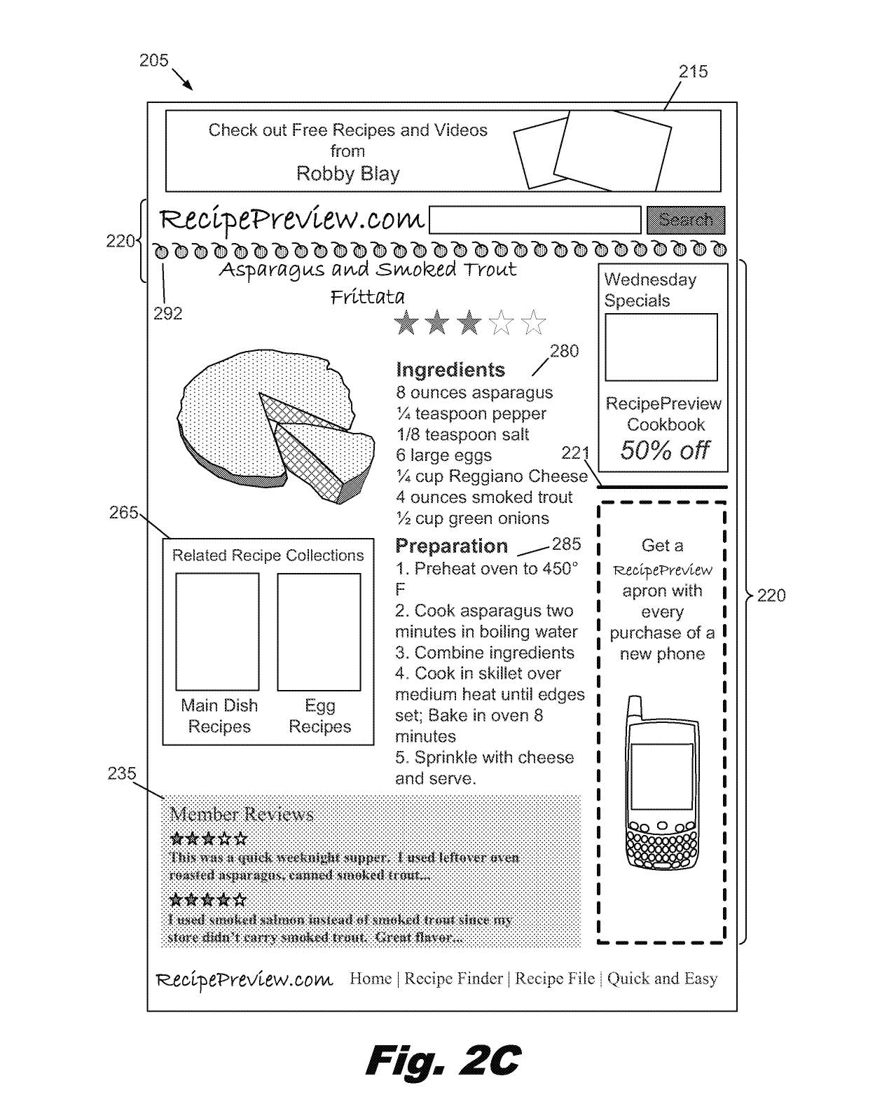

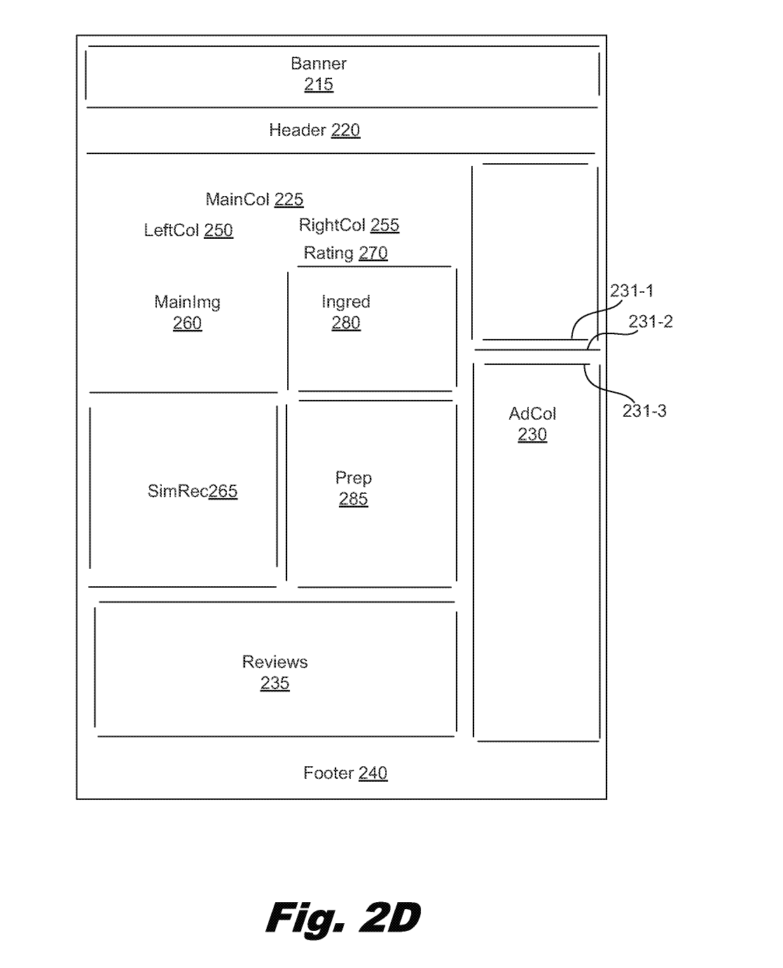

FIG. 2A shows one illustrative embodiment of a visual separator algorithm (202) which detects visual separators by analyzing the code associated with a web page. HyperText Markup Language (HTML) is currently the predominant markup language for web pages and provides a means for creating structure documents by denoting structural semantics for text such as headings, paragraphs, lists, links, embedded images and objects, and scripts from other languages. HTML is used only as an illustrative example. The principles described herein can be applied to a wide variety of markup languages, including but not limited to eXensible HyperText Markup Language (XHTML), eXensible Markup Language (XML), Scalable Vector Graphics (SVG), Xml User interface Language (XUL), or other markup languages.

The mark up language is often used in combination with a variety of other protocols which extend its capabilities. For example, HTML often uses Document Object Model (DOM) trees, hierarchies and elements. DOM is a cross-platform and language independent convention for representing and interacting with web page elements in mark up languages. HTML and DOM are also combined with style sheet languages such as Cascading Style Sheets (CSS) which describe the presentation semantics of a document written in the markup language.

In the illustrative visual separator algorithm (202) shown in FIG. 2A, the web page (110, FIG. 1) is received by the web page analysis device (105, FIG. 1) (step 204). A DOM tree and visual information (such as the coordinates of each DOM node) are derived from the web page code (step 214). For example, the DOM tree and visual information may be generated by a web render engine such as WEBKIT® or other graphical layout engine. As used in the specification and appended claims, the terms “DOM node(s)” or “node(s)” refers to object models which are derived from the HTML code and placed in a hierarchal tree structure. The DOM nodes make up the hierarchal tree and may occur at any level of the hierarchal tree. Each DOM node may contain multiple properties which indicate visual separators in the web page. For example, the DOM nodes may have HTML tags, borders, background colors, and image repetition. Each of these properties may indicate a visual separator within the web page.

The DOM tree is then traversed to generate a DOM node list (step 224). Each node is then analyzed to detect visual separators by a DOM node analysis engine (234). The node analysis may include a number of steps including: tag name analysis (step 224); border property analysis (step 254); detecting background color differences (step 264); and recognizing image repetition (step 274). Each of these steps in detecting visual separators is discussed in greater detail below.

Tag name analysis (step 224) includes recognizing HTML tags which directly create visual separators. For example, the HTML tag <hr> creates a horizontal line in an HTML page. This horizontal line is a visual separator. Another example is the HTML tag <textarea> which defines a multi-line text area which can hold an unlimited number of characters. The size of a textarea can be specified by row or column attributes or through CSS height and width properties. The edges/borders of an area defined by <textarea> can represent a visual separation between the text and the surrounding elements. According to one embodiment, the tag name analysis is designed to identify HTML tags which directly create one or more horizontal or vertical visual separators.

Border property analysis (step 254) recognizes visual separators which are created by HTML border properties which are wider than zero. For example, the following code represents a DOM “div” element which uses a CSS <border> property to surround text with a dotted orange border which is two pixels wide.

```
  <style type=“text/css”>
  div.styled {
  border:2px dotted #ff9900;
  }
  </style>
  <div class=“styled”>This “div” is styled using the CSS border
property to surround this text with a dotted orange border. </div>
```

The <border> CSS property used in this example is a flexible command which can be used to create a wide variety of borders which surround or partially surround images, text or other elements. Because commands such as the <border> CSS property create lines horizontal or vertical lines, patterns, or whitespaces, they can be analyzed to produce visual separations present in a web page. A variety of other commands and methods can also be used to create borders in web pages. The border property analysis may also be configured to detect visual separators which are directly or indirectly created by a wide variety of borders and border commands. The border property analysis then outputs the visual separators which correspond to the borders which have widths which are greater than zero pixels.

Background color differences (step 264) can be used to identify visual separators (step 264). According to one illustrative embodiment, the background colors of various DOM nodes are compared with the background colors of adjacent or parent DOM nodes. If the difference in background colors is greater than a threshold value, the transition between the backgrounds is interpreted as a visual separation. The threshold value may be a predetermined value or may be dynamically determined from characteristics of the web page being analyzed.

The visual separations created by differences in background color are typically located along the transition between the different adjacent backgrounds. For example, following web code defines a DOM header element “h4” which has a white background color: h4 {background-color: white;}. Similarly, a DOM paragraph element “p” with a can be defined which has a blue background called out in hexadecimal notation: p {background-color: #1078E1;}. If the header and paragraph are adjacent to each other, the different background colors will create a visual separation between the two elements,

Small background images within a webpage can form visual separators by repetition in horizontal or vertical directions. By analyzing the web code for repetition of small background images (step 274) these visual separators can be identified.

As visual separators which are derived from the node properties are identified and output by the DOM node analysis engine (234), they are added to a visual separator list (284) as shown by the arrows on the right side of the flowchart. The DOM node analysis engine (234) repeats the analysis for each node.

In some embodiments, visual separators generated by different methods are also added to the visual separator list (284). For example, visual separators can be extracted from a rendered image of the web page. Techniques and examples of extracting visual separators from images of a web page is further discussed in PCT App. No. PCT/CN2010/______ attorney docket number 201001634, entitled “Detecting Separator Line in a Web Page,” to Suk Hwan Lim et al., filed on Jul. XX, 2010, which is incorporated by herein by reference in its entirety.

After the visual separator list is assembled, visual separators with one or more coinciding attributes are merged (step 294) by a merge module. For example, if both a border and a background result in the identification of two overlaying visual separators, the two visual separators may be merged to form a single visual separator. In some embodiments, intersecting separators may be merged to form more distinct boundaries within the web page. For example, if horizontal and vertical separators intersect, the two separators could be merged to form a portion of a rectangle. In some embodiments, the visual separators may not actually overly each other, but be parallel and adjacent to each other. These visual separators could also be merged. The merging of redundant visual separators (step 294) results in a final visual separator list (296) which represents the detected graphic divisions of the web page.

FIGS. 2B-2D show one illustrative example of the web page analysis device (105, FIG. 1) implementing the visual separator detection algorithm (202, FIG. 2).

FIG. 2B shows an illustrative DOM tree (200) derived from web page code. The DOM tree (200) shows the hierarchy of DOM elements in the web page with each element labeled with a name and a tag. For example, the banner element (215) is named “Banner” and a tag “div”. The DOM tag “div” indicates that styles in this element are defined in Cascading Style Sheets (CSS) language. Additionally, the DOM tag “img” indicates the presence of an image; a “p” tag indicates a paragraph; and the “ui” tag indicates a list. Each of these elements can be further defined by a number of CSS properties.

The root element in this DOM tree is the Content element (210) which has six sub-trees (209): Banner (215); Header (220); MainCol (225); Adcol (230); Reviews (235); and Footer (240). For purposes of illustration, subelements (250-285) are shown for only for the MainCol sub-tree (225). Dashed lines extending to the right of the other sub-trees show the continuation of the sub-trees with elements which are not illustrated in FIG. 2A.

The MainCol sub-tree (225) has two elements, LeftCol (250) and RightCol (225), at the next hierarchal level. LeftCol (250) has two elements at the lowest hierarchal level (257): Mainlmg (260) and SimRec (265). The RightCol (225) has four elements at the lowest hierarchal level (257): Rating (270), Descr (275), Ingred (280), and Prep (285). The elements at the lowest hierarchal level (257) are also called leaf nodes.

FIG. 2C is diagram of an illustrative web page (205) associated with DOM tree (202; FIG. 2B) described in FIG. 2B. The various regions in the web page (205) correspond to the elements in the DOM tree (200; FIG. 2A). The illustrative visual separator algorithm (202, FIG. 2B) begins to analyze each node in the DOM tree (200, FIG. 2A) to detect visual separators using a node analysis engine (234, FIG. 2B). As discussed above, the visual separator algorithm (202) analyses the DOM tree, rendered visual information and other code elements. The web page layout presented in FIG. 2C is shown for purposes of explanation and is not directly analyzed by the visual separator algorithm.

The visual separator algorithm (202, FIG. 2B) may begin by analyzing the Banner element (215) and its component nodes. The algorithm identifies that the Banner element (215) is surrounded by a solid border and derives a number of corresponding visual separators. The algorithm may then analyze the Header element (220) and determine that it contains a row of repeated images (292) which span the web page. In this case, the row of repeated images (292) is made up of a horizontal array of cherries. The algorithm identifies this row of repeated images (292) as a visual separator. In each case the visual separators are added to a visual separator list (284, FIG. 2A).

The algorithm continues by analyzing the AdCol element (230), which creates a column on the right hand side of the web page that contains advertisements. The algorithm recognizes a number of borders and an <hr> tag which produces a horizontal dividing line (221). The algorithm next analyzes the MainCol element (225; FIG. 2B) which contains a list, Ingred (285), and a text area, Prep (285). The list contains the ingredients to make the recipe and the text area describes how the ingredients are prepared. The text area is defined by the <textarea> tag, which the algorithm recognizes as defining visual separators. The algorithm also recognizes the borders of the SimRec element (265) as visual separators.

The algorithm analyzes the Reviews element (235) and recognizes that it has a background color which is substantially different from backgrounds of the surrounding elements of the web page. For example, the algorithm may compare the background color of the Reviews element (235) to is parent node, Content (210). Because the web page area of child nodes is typically encompassed by that of a parent node, the comparison of background colors of between child and parent nodes can be particularly effective.

After determining the difference between background colors, this difference is compared to a threshold. If the difference is greater than the threshold, the algorithm adds appropriate visual separators to the visual separator list (step 284). If the difference is less than the threshold, the algorithm determines that no visual separators should be added to the visual separator list.

As discussed above, the threshold value can be determined in a number of ways. A first method for determining the threshold value may be to set a predetermined level for the color difference that creates a visual separator. A more contextual approach to determining the threshold value is to analyze the web page to calculated the threshold. For example, the threshold value may be determined by examining background color differences between parent and child nodes across the whole web page. If the range of differences across the web page are low, the threshold will be correspondingly low. If the range of differences are large, the threshold will be correspondingly large. This adapts the threshold to the visual context in the web page and allows for more accurate determinations of visual separators based on background colors.

FIG. 2C shows an outline of the web page with the visual separators illustrated as horizontal and vertical lines on the web page. The numeric identifiers of various DOM nodes are illustrated in the corresponding areas of the web page. The algorithm then merges visual separators (step 294). For example, in the area defined by the Adcol element (230), there are three adjacent horizontal separators (231-1, 231-2, and 231-3). The upper and lower visual separators (231-1, 231-3) were identified from the borders surrounding advertisements, while center visual separator (231-2) was identified from the <hr> tag. These three visual separators can be combined into a single separator which defines a boundary between the two advertisement portions of the web page. Similarly, a number of other redundant horizontal or vertical visual separators can be combined. As used in the specification and appended claims, the term “redundant visual separators” refers to visual separators which denote the same graphical division in a web page.

The merging of redundant visual separators (step 294, FIG. 2A) results in a final visual separator list (296, FIG. 2A) which represents the graphic divisions of the web page. The visual separators in the final visual separator list can be used for a variety of purposes, including dividing the web page into coherent segments and identifying which one of the coherent segments contains main content of the web page. The main content of the web page can then be extracted to facilitate functions such as printing, internet search, archiving, or other information management functions. Various applications of visual separators are further described in PCT App. No. PCT/CN2010/______, attorney docket number 201001728, entitled “Selection of Main Content in Web Pages,” to Suk Hwan Lim et al., filed on Jul. XX, 2010, which is incorporated by herein by reference in its entirety.

For purposes of illustration, the horizontal and vertical visual separators are not show as being joined at the corners in FIG. 2D, even if they were derived from a border, text area or other element which clearly defines the corners. This gap between the vertical and horizontal visual separators allows each visual separator to be individually identified. However, the visual separator algorithm as implemented may preserve and use information about intersections between horizontal and vertical visual separators.

In sum, the visual separator algorithm and system described above are effective in automatically extracting visual separators from web code such as HTML, DOM, and CSS code elements. The visual separator detection effectively leverages the web page HTML content, such as tag names, tag properties, color differences, and image repetition. The use of this information provides detection results which are accurate and meaningful. Further, this HTML based approach can be performed quickly and with minimal memory requirements.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for detection of visual separators in web pages using code analysis comprising:
receiving a web page by a web page analysis device;
generating a DOM tree from the web page;
extracting rendered visual information from the web page, in which the DOM tree and rendered visual information comprises web code;
analyzing the web code, using the web page analysis device, by analyzing each node in the DOM tree for multiple node properties which indicate visual separators in the web page;
adding each visual separator derived from one of the properties of a node to a visual separator list; and
merging redundant visual separators contained within the visual separator list.

2. The method of claim 1, in which analyzing the web code comprises identifying the code elements which directly create visual separators.

3. The method of claim 2, in which the code elements which directly create visual separators are HTML tags which directly create at least one of: a horizontal visual separator and a vertical visual separator.

4. The method of claim 2, in which the code elements which directly create visual separators comprise at least one of: an <hr> tag and a <textarea> tag.

5. The method of claim 1, in which analyzing the web code comprises:
identifying HTML border properties which are wider than zero; and
outputting visual separators which correspond to HTML borders which are wider than zero.

6. The method of claim 1, in which analyzing the web code comprises identifying differences in background colors between spatially adjacent DOM nodes.

7. The method of claim 6, in which identifying differences in background colors comprises comparing a background color of a child node to a background color of its parent node.

8. The method of claim 6, in which analyzing the web code further comprises:
comparing the difference in background colors of spatially adjacent DOM nodes to a threshold;
if the difference in background colors exceeds the threshold, defining a visual separator corresponding to the boundary between the different background colors.

9. The method of claim 8, in which the threshold is calculated based on a color distribution of backgrounds between parent nodes and child nodes in the web page.

10. The method of claim 1, in which analyzing the web code further comprising analyzing repeated images to determine if the repeated images create a visual separator in the web page.

11. The method of claim 1, in which merging redundant visual separators comprises merging adjacent visual separators which are mutually offset and parallel.

12. The method of claim 1, further comprising adding visual separators extracted from a rendered image of the web page to the visual separator list.

13. The method of claim 1, further comprising using the visual separators to divide a web page into regions; in which a portion of the web page which is crossed by a visual separator is segmented into two separate regions.

14. A method for visual separator detection in web pages using HTML code analysis comprises:
receiving a web page and its associated web code by a web page analysis device;
generating a DOM tree from the web page and extracting rendered visual information from the web page;
traversing the DOM tree and analyzing each node in the DOM tree for: HTML tags which directly create a visual separator, HTML border properties which are wider than zero, differences in background colors between spatially adjacent DOM nodes, and repeated images which create a visual separator in the web page.

15. A web page analysis device for visual separator detection in web pages comprises:
a memory for storing a visual separator algorithm;
a processing unit for accepting the visual separator algorithm from the memory and executing the visual separator algorithm; and
a network adapter for receiving a web page from a web page server;
in which the visual separator algorithm comprises:
a DOM node analysis engine which accepts web page derived DOM tree and visual information; in which the DOM node analysis engine identifies visual separators by analyzing DOM nodes in the DOM tree for at least one of: tag names, border properties, color differences, and image repetition; the visual separators being added to a visual separator list;
a merge module for merging redundant visual separators to produce a final visual separator list.
